(19) United States
(12) Patent Application Publication
(10) Pub. No.: US 2024/0256965 A1
(43) Pub. Date: Aug. 1, 2024

(54) Instruction Fine-Tuning Machine-Learned Models Using Intermediate Reasoning Steps

(71) Applicant: Google LLC, Mountain View, CA (US)

(72) Inventors: Hyung Won Chung, Mountain View, CA (US); Barret Zoph, San Francisco, CA (US); Dengyong Zhou, Redmond, WA (US); Liam Fedus, Palo Alto, CA (US); Shayne Longpre, Surrey (CA); Le Hou, South Setauket, NY (US); Yi Tay, Singapore (SG); Jason Weng Wei, Mountain View, CA (US); Siddhartha Brahma, San Jose, CA (US); Quoc V. Le, Sunnyvale, CA (US)

(21) Appl. No.: 18/424,624

(22) Filed: Jan. 26, 2024

(30) Foreign Application Priority Data
Jan. 27, 2023 (SG) 10202300219X

(51) Int. Cl. G06N 20/00

(52) U.S. Cl. CPC G06N 20/00

(57) ABSTRACT

An example method for training a machine-learned sequence processing model includes obtaining a plurality of training examples for training the machine-learned sequence processing model. For each respective training example of the plurality of training examples, the example method includes: obtaining a respective query associated with the respective training example; inputting the respective query to the machine-learned sequence processing model; obtaining, from the machine-learned sequence processing model a response to the respective query and a trace of intermediate states from the respective query to the response; evaluating the response using a ground truth response associated with the respective training example; evaluating the trace using a ground truth trace associated with the respective training example; and updating one or more parameters of the machine-learned sequence processing model based on the evaluation of the response and based on the evaluation of the trace.

### PRIORITY

The present application claims priority to and the benefit of Singapore Patent Application No. 10202300219X, filed Jan. 27, 2023. Singapore Patent Application No. 10202300219X is hereby incorporated by reference herein in its entirety.

### FIELD

The present disclosure relates generally to machine learning processes and machine-learned devices and systems. More particularly, the present disclosure relates to training machine-learned models using intermediate reasoning steps.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include a computer-implemented method for training a machine-learned sequence processing model. The example method can include obtaining, by a computing system including one or more processors, a plurality of training examples for training the machine-learned sequence processing model, wherein each training example of the plurality of training examples includes an example query, an example response to the query, and an example trace of intermediate states from the example query to the example response. The example method can include performing one or more operations for each respective training example of the plurality of training examples. The example method can include obtaining, by the computing system, a respective query associated with the respective training example. The example method can include inputting, by the computing system, the respective query to the machine-learned sequence processing model. The example method can include obtaining, by the computing system and from the machine-learned sequence processing model: a response to the respective query; and a trace of intermediate states from the respective query to the response. The example method can include evaluating, by the computing system, the response using a ground truth response associated with the respective training example. The example method can include evaluating, by the computing system, the trace using a ground truth trace associated with the respective training example, wherein the ground truth trace was obtained from annotations that were input by a human user after being presented with the query and the ground truth response, wherein the annotations include a description of step-by-step reasoning between the respective query and the ground truth response. The example method can include updating, by the computing system, one or more parameters of the machine-learned sequence processing model based on the evaluation of the response and based on the evaluation of the trace.

Example aspects of the present disclosure provide an example computing system for training a machine-learned sequence processing model. The example computing system can include one or more processors. The example computing system can include one or more non-transitory computer-readable media storing instructions that are executable by the one or more processors to cause the computing system to perform operations. In the example computing system, the operations can include obtaining a plurality of training examples for training the machine-learned sequence processing model, wherein each training example of the plurality of training examples includes an example query, an example response to the query, and an example trace of intermediate states from the example query to the example response. In the example computing system, the operations can include, for each respective training example of the plurality of training examples: obtaining a respective query associated with the respective training example; inputting the respective query to the machine-learned sequence processing model; obtaining, from the machine-learned sequence processing model: a response to the respective query; and a trace of intermediate states from the respective query to the response; evaluating the response using a ground truth response associated with the respective training example; evaluating the trace using a ground truth trace associated with the respective training example, wherein the ground truth trace was obtained from annotations that were input by a human user after being presented with the query and the ground truth response, wherein the annotations include a description of step-by-step reasoning between the respective query and the ground truth response; and updating one or more parameters of the machine-learned sequence processing model based on the evaluation of the response and based on the evaluation of the trace.

Example aspects of the present disclosure provide an example computing system. The example computing system can include one or more processors. The example computing system can include one or more non-transitory computer-readable media storing a machine-learned sequence processing model. The machine-learned model can be trained using the example method. The example computing system can include one or more non-transitory computer-readable media storing instructions that are executable by the one or more processors to cause the computing system to perform operations, the operations including: inputting a runtime query to the machine-learned sequence processing model; and receiving a runtime response from the machine-learned sequence processing model, wherein the runtime response includes a runtime trace of intermediate states from the runtime query to the runtime response.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system for performing finetuning using training examples with ground truth trace data according to example implementations of aspects of the present disclosure;

FIG. 2 is an example illustration of a mixed training procedures that uses training examples with and without ground truth trace information according to example implementations of aspects of the present disclosure;

FIG. 3 is a plot of example results of tests according to example implementations of aspects of the present disclosure;

FIG. 4 is a plot of example results of tests according to example implementations of aspects of the present disclosure;

FIG. 5 is a plot of example results of tests according to example implementations of aspects of the present disclosure;

FIG. 6 is a plot of example results of tests according to example implementations of aspects of the present disclosure;

FIG. 7 is a flow chart diagram illustrating an example method for training a machine-learned model according to example implementations of aspects of the present disclosure;

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

FIG. 15 is a block diagram of an example networked computing system according to example implementations of aspects of the present disclosure;

FIG. 16 is a block diagram of an example computing device according to example implementations of aspects of the present disclosure; and

FIG. 17 is a block diagram of an example computing device according to example implementations of aspects of the present disclosure.

### DETAILED DESCRIPTION

Generally, the present disclosure is directed to devices, systems, and techniques for training machine-learned models using intermediate reasoning steps. In particular, the present disclosure relates to instruction finetuning over datasets that include ground-truth chain-of-thought reasoning traces for a portion of the training examples to provide supervised training signals of not only a correct answer but also the rationale behind the answer. By performing supervised training over the intermediate states in responding to a given query, the models can learn new connections between information in the training data that may otherwise be absent.

In an example, a training dataset can include various different training examples. A set of training examples can include ground truth. In an example, each training example in this set includes an input query, a corresponding output response, and a trace that explains the intermediate steps or thought process (e.g., “chain-of-thought”) from the query to the response. This trace can provide a step-by-step explanation of a human's thought process in solving the problem. Performing supervised training over these examples can help understand different approaches for problem solving in different contexts.

For example, the training dataset can span diverse subject matter that invoke various forms of reasoning (e.g., deductive, inductive, and abductive reasoning). Diverse types of reasoning can be reflected in the labeled traces generated by human annotators. This diversity can help the model to generalize its reasoning capabilities across a wide array of contexts. For instance, a model trained on a diverse set of tasks could be better equipped to handle unfamiliar problems by applying learned reasoning patterns in new ways.

To facilitate an efficient training infrastructure over diverse datasets, example implementations of the present disclosure can use a system of datasets, task categories, tasks, and templates to construct numerous training examples for training. For instance, a dataset can include baseline input and output data. A task category can include a type of processing operations that is to be performed using the data from the dataset. The task can be a combination of a task category as applied to data from a particular dataset. To construct an input to the model to perform the task, a template can be selected and data associated with the task can be populated into the template.

Advantageously, such a system can allow for the dynamic selection and combination of these elements to generate large amounts of training data. For instance, a dataset containing historical facts may be selected, paired with a task category such as ‘date matching,’ and further combined with an instruction template designed to elicit step-by-step reasoning for matching events with their corresponding dates. The template can be populated with specific instances from the dataset, resulting in queries that ask the model to determine the year in which a particular event occurred.

Various aspects of the query generation can be randomized to help the model focus on learning to process the instructions independent from the precise formatting. For example, populating the instruction template can include using one or more exemplar delimiters selected randomly from a plurality of exemplar delimiters. This approach can introduce randomness in the formatting of training examples, mimicking the variability that the model can encounter in real-world applications. Different delimiters, such as “Q:”/“A:” or bullet points, can be used to separate parts of an example, such as the question from the answer or the steps in a reasoning chain. By randomly selecting these delimiters during training data generation, models can be encouraged to focus on the content and structure of the reasoning rather than the superficial formatting cues. For example, a model might be trained on examples where steps in a mathematical proof are separated by line breaks in some instances and by numbered lists in others, thereby learning to recognize the logical sequence of steps regardless of formatting.

The present disclosure offers a technical solution to the problem of enhancing the reasoning capabilities of machine-learned models, particularly in the context of processing and understanding complex queries that require intermediate logical steps. An example technical effect achieved by the disclosed techniques is an improvement in the model's ability to process information in a manner learned from actual human reasoning, which involves understanding the query, decomposing it into intermediate steps, and synthesizing these steps to arrive at a final answer. This improvement reflects a technical advancement in the field of natural language processing and artificial intelligence, as it enables models to handle tasks that traditionally required human cognitive abilities.

One example technical benefit of the disclosed technology is the ability of the machine-learned model to learn from intermediate reasoning steps that might not inherently be present in the input data. The use of supervised learning over intermediate reasoning paths can provide a much stronger training signal to the model as compared to the raw answer alone.

Furthermore, the disclosed technology results in a technical effect of increased adaptability and generalization of machine-learned models to various domains and types of tasks. By training on a heterogeneous mixture of datasets encompassing different subjects and reasoning types, the model acquires a broader understanding of language and logic patterns. This technical effect is beneficial for the development of versatile models capable of performing in diverse applications, ranging from academic problem-solving to real-world decision-making processes. Such an enhancement in generalization abilities represents a significant technical contribution to the state of the art.

Another technical effect arising from the disclosed technology is the improvement in the interpretability and transparency of machine-learned models. The inclusion of ground-truth chain-of-thought reasoning traces in training data allows the model to not only reach correct conclusions but also learn to provide comprehensible explanations for its outputs. This technical effect addresses the challenge of the “black box” nature of many artificial intelligence systems, providing a technical means for users to verify the model's outputs. For instance, in medical diagnostics, a model can learn to articulate the logical steps leading to a particular analysis of input data, thereby offering clinicians a clear rationale that can be assessed directly.

Various example implementations are described herein with respect to the accompanying Figures.

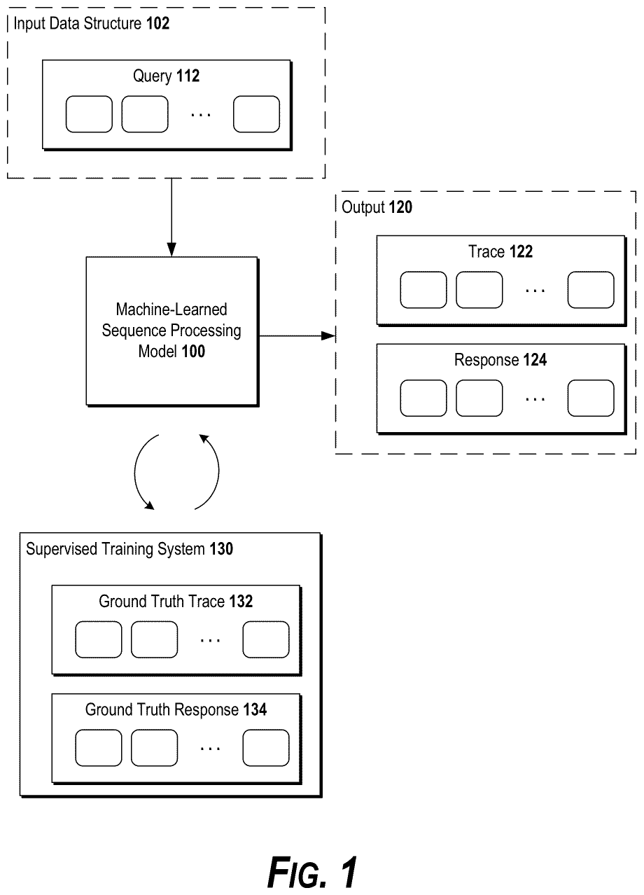

FIG. 1 is a block diagram of an example system for training a machine-learned sequence processing model 100. The example system can include an input data structure 102 which includes one or more queries 112. Queries 112 can be fed into machine-learned sequence processing model 100 for processing. Machine-learned sequence processing model 100 can generate output 120. Output 120 can include trace 122 and response 124. Trace 122 can provide a series of intermediate reasoning steps or “chain-of-thought” descriptions that the model generates based on input queries 112. Response 124 can be the output from the model directly responsive to query 112. Supervised training system 130 can evaluate output 120 against labeled ground truth trace 132 and ground truth response 134.

Machine-learned sequence processing model 100 can be or include any variety of machine-learned model that is configured to process sequences of data. For example, machine-learned sequence processing model 100 can include a transformer-based model. Machine-learned sequence processing model 100 can include one or more transformer layers that attend over an input sequence. Machine-learned sequence processing model 100 can autoregressively generate next items in the sequence based on the input sequence. The model can be pretrained on large corpora of text data to learn a wide range of language patterns and then further refined through the instruction finetuning process described herein.

Machine-learned sequence processing model 100 can include an attention mechanism that allows the model to focus on different parts of the input sequence when generating each portion of the output sequence. For example, when processing a complex sentence, the model can use attention to weigh the importance of each word in relation to the others.

Machine-learned sequence processing model 100 can include an embedding layer that transforms input tokens into high-dimensional vectors. These vectors can serve as the initial representation of the input data and capture semantic and syntactic information about each token. As the data passes through subsequent layers of the model, these embeddings can be refined. The model can leverage these refined embeddings to generate traces and responses that align with the behavior learned during training.

Machine-learned sequence processing model 100 can include one or more output layers that generate probabilities over a vocabulary of possible output tokens. At each step in the generation process, the model can use these probabilities to select a next token (e.g., a most likely next token, a beam search over likely tokens, temperature-based sampling, etc.), building up a response one token at a time. The model can also be trained to generate multiple possible outputs and select the most coherent and relevant one based on the context provided by the input sequence and the instruction templates. The model can generate multiple continuations for each input and compute a similarity metric over the group to identify a representative continuation that enjoys majority or plurality support.

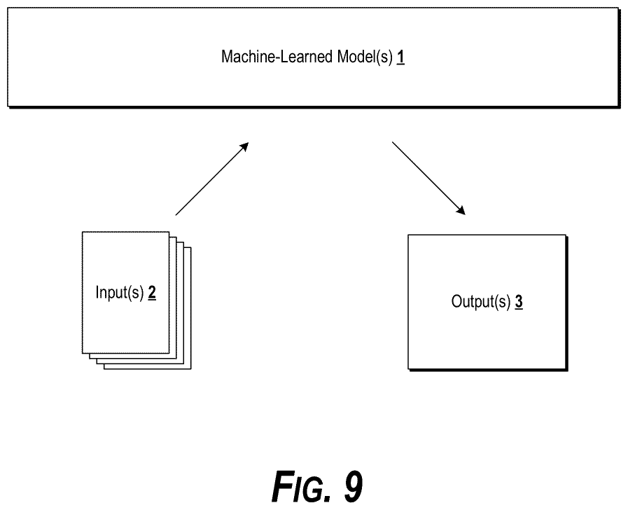

Further example details regarding machine-learned model 100 are discussed below with respect to FIGS. 9 to 17.

Input data structure 102 can include a formatted query 112 that is constructed to prompt machine-learned sequence processing model 100 to perform a specific task. This query can be a text-based question, a set of instructions, or a problem statement designed to elicit a particular type of reasoning or response from the model.

Input data structure 102 can include various metadata associated with the query that provides additional context or instructions for the model. This metadata can include information such as the domain of the query (e.g., science, mathematics, history), the complexity level, or the intended use of the model's response. By incorporating this metadata, the input data structure can help the model tailor its processing and response generation to the specific requirements of the task at hand.

Input data structure 102 can include placeholders or markers that indicate where the model should insert its generated reasoning steps or final response. These placeholders can be part of the instruction template and serve as cues for the model to structure its output in a predetermined format. For example, a placeholder might signal the start of a reasoning trace or the point at which a conclusion should be presented.

Input data structure 102 can include a set of exemplar inputs and outputs that serve as a reference for the model during the fine-tuning process. These exemplars can be previous instances where the model or a human expert has successfully processed similar queries, providing an illustration for how the model is to perform the current task. The exemplars can help the model understand the desired format and level of detail for its responses, as well as the reasoning process that leads to accurate outcomes.

An example input data structure 102 for a zero-shot implementation can include an instruction with query 112. In an example, the instruction can be “Answer the following yes/no question by reasoning step-by-step.” The total query can include “Answer the following yes/no question by reasoning step-by-step. Can you write a whole Haiku in a single tweet?” The second sentence can be the query for which a response is desired.

An example input data structure 102 for a single or few-shot implementation can include a similar arrangement, except that the template can include exemplars (e.g., an exemplar query, an exemplar trace, and an exemplar response). In an example, a total query can include the following: “Q: Answer the following yes/no question by reasoning step-by-step. Could a dandelion suffer from hepatitis? A: Hepatitis only affects organisms with livers. Dandelions don't have a liver. The answer is no. Q: Answer the following yes/no question by reasoning step-by-step. Can you write a whole Haiku in a single tweet? A:”

Although examples of various inputs and outputs (e.g., input data structure 102, output 120) are described herein with respect to textual content represented therein, it is to be understood that input data structure 102 can additionally or alternatively be in a tokenized state or embedded state in which textual content may not be explicitly stored. The structured, ordering, and configurations of input data structure 102 as described herein can apply broadly to string-based inputs (e.g., a string representing textual content of an input sequence”), image-based inputs (e.g., in raster or vector format), tokenized/patched inputs (e.g., a sequence of data objects containing sub-parts of the original input data), or embedded inputs (e.g., vector embeddings of tokens or patches).

Furthermore, it is to be understood that inputs and/or outputs can be unimodal or multimodal. For example, inputs or outputs can include data from multiple different data modalities (e.g., text, image, audio, video, etc.).

Query 112 can present substantially any type of problem, question, or task to be performed. For instance, query 112 can include substantially any problem capable of being explained, reasoned, or otherwise expressed with symbols, images, language, etc. For example, the query 112 can include mathematical queries, logic queries, knowledge queries, generative queries, summary queries, analytics queries, retrieval queries, image processing queries, etc.

Output 120 can include a data structure that contains a response from model 100. The data structure can be represented by, e.g., a string, a database object, etc.

Trace 122 can include a detailed account of the intermediate steps or logical progressions that the machine-learned sequence processing model 100 recounts en route to arrive at the final output or response to an input query. Trace 122 can include annotations or explanations that accompany each step of the reasoning process. These annotations can be in the form of natural language descriptions, mathematical expressions, or visual representations, depending on the nature of the task and the model's design.

Trace 122 can include one or more intermediate states from query 112 to response 124. For example, intermediate states can include intermediate values associated with component subtasks, declarations of knowns determined (explicitly or implicitly) from the query, logical steps to progress from a problem to a solution, a log of subtasks performed to generate the response, tools to use to obtain relevant information/prerequisites, assumptions made to resolve the query, etc.

Trace 122 can include conditional branches or alternative paths may have been considered before settling on the final response. This aspect of the trace can highlight the model's ability to evaluate different possibilities and make informed choices.

Trace 122 can include cross-references to relevant parts of the input data or to external sources that contain information relevant to the reasoning (e.g., reference sources, citations to passages in the input, etc.). These cross-references can provide a way to help verify the accuracy and relevance of the information that the model indicates as relevant. They can also facilitate learning by pointing users to additional resources for further exploration.

Response 124 can embody the performance of the task instructed in query 112. Response 124 can be the answer to a question, commentary on a topic, code for calling an external tool, creative generation, etc.

Generally, response 124 can include a fulfillment of query 112 (e.g., including an expression of an inability to fulfill the query, etc.). In some embodiments, trace 122 can be generated based on a pattern set by one or more instructive traces in the input data structure 102 (e.g., a single- or few-shot exemplar).

Supervised training system 130 can include one or more computing systems that is configured to provide training inputs to machine-learned model 100 and receive training outputs from machine-learned model 100. Supervised training system 130 can evaluate outputs 120 against ground truth data.

Supervised training system 130 can evaluate output trace 122 against ground truth trace 132. Ground truth trace 132 can be obtained from human annotators. For instance, a preexisting training example with an input and an output can be provided to a display system for interfacing with a human annotator. The display system can present the preexisting training example to the human annotator. The display system can receive inputs descriptive of step-by-step rationale that supports the output given the input. This rationale can include information that was absent from the original training example (e.g., reflecting the world knowledge of the human annotator). In this manner, for instance, using ground truth traces 132 generated from inputs of human annotators can provide a rich training signal for training machine-learned model 100.

Supervised training system 130 can evaluate output response 124 against ground truth response 134. Ground truth response 134 can be obtained from an underlying training dataset from which query 112 is drawn.

Supervised training system 130 can use a variety of loss functions to evaluate output 120. Supervised training system 130 can compute a loss value that penalizes a deviation of the output 120 from the ground truth data. Supervised training system 130 can evaluate a probability generated by the model 100 for one or more words or tokens in the ground truth data. The deviation between the ground truth and the output 120 can be determined based on a difference in probability mass over the vocabulary of model 100. The deviation can be computed using a divergence between the output probability distributions over the output vocabulary. Supervised training system 130 can use a cross-entropy loss (e.g., a mean cross-entropy loss over the output tokens). Supervised training system 130 can use a ROUGE loss.

A fine-tuning sequence can include fine-tuning on training examples without ground truth traces. For instance, the model 100 can be trained simply based on the response output (e.g., no generated trace). The same model can also be trained using training examples with ground truth traces. A mixture of both types of training examples can provide a robust foundation for a multi-task model. In some examples, the proportion of training examples with ground truth traces can be less than 10% (e.g., 3%, 1.8%, etc.).

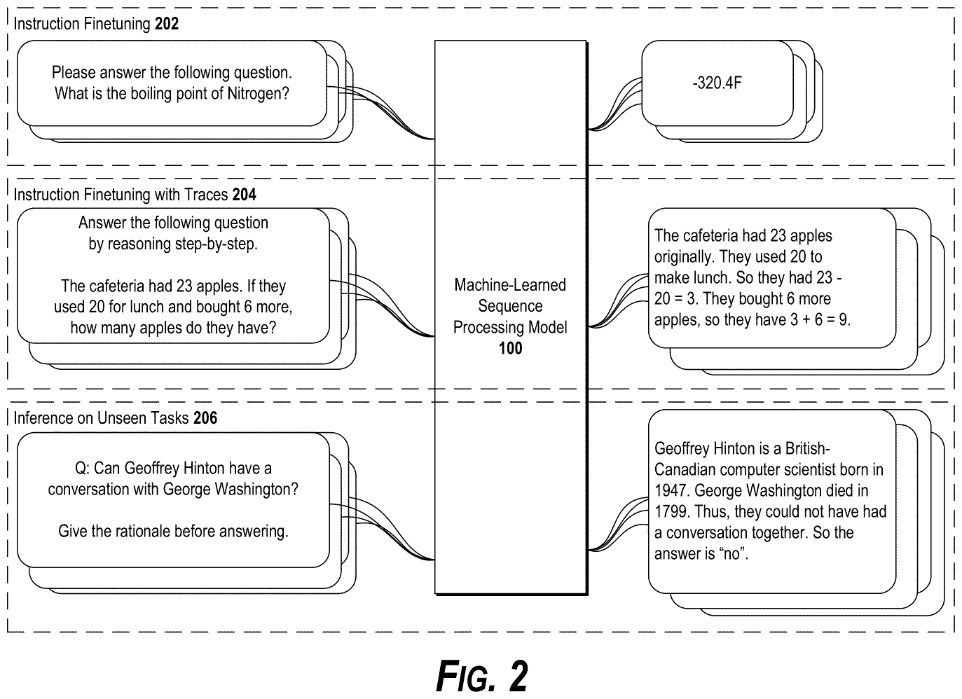

FIG. 2 provides a visual representation of the training and inference stages for an example machine-learned sequence processing model, such as model 100. The diagram is divided into three main modes: instruction finetuning 202, instruction finetuning with ground truth traces 204, and inference on unseen tasks 206 (e.g., at runtime or test time).

In instruction finetuning 202, the model can be fine-tuned using direct instruction (e.g., without intermediate reasoning steps or traces). For instance, an example query is provided, such as “Please answer the following question. What is the boiling point of Nitrogen?” The model processes this input and generates a direct response, such as “−320.4F.” Instruction finetuning 202 can include evaluating the model's response and updating the model based on the evaluation. Instruction finetuning 202 can leverage large quantities of existing data that may lack ground truth traces.

Training mode instruction finetuning with traces 204 can involve finetuning the model with an emphasis on generating intermediate reasoning steps, or traces, that lead to the final response. The example query in this stage is more complex and can benefit from step-by-step reasoning. The model not only provides the correct answer, but also includes a trace detailing the reasoning process. This training mode can help induce improved reasoning capabilities in the model. Instruction finetuning with traces 204 can include evaluating the model's response (e.g., including any generated trace) to increase a likelihood of generating a ground truth trace.

After the model has been finetuned using modes 202 and 204, it can then be tested on unseen tasks to evaluate its ability to generalize and apply learned reasoning skills to new scenarios. The example query in this stage requires historical knowledge and reasoning. The model's response demonstrates its ability to use reasoning and historical facts to conclude that a conversation is not possible.

The inference mode on unseen tasks can benefit from both types of training stages. By incorporating both direct responses and reasoning traces in its training, the model can be better equipped to handle complex queries. The model can be equipped with the ability to decompose complex tasks into easier components, which can improve a performance of the model in predicting the ultimate answer.

Training modes 202 and 204 can be conducted sequentially or simultaneously. For instance, training batches can include examples from each mode.

### Example Results

To help illustrate example implementations of techniques of the present disclosure, example results are provided herein. In these example tests, several models are instruction-finetuned on a collection of data sources with a variety of instruction template types. The present disclosure refers to this finetuning procedure as “Flan” and prepends “Flan” to the resulting finetuned models (e.g., Flan-PaLM to indicate a fine-tuned PaLM model according to Flan).

In some example tests, finetuning was performed with up to 1,836 finetuning tasks by combining four mixtures: Muffin, T0-SF, NIV2, and CoT. Muffin (80 tasks) includes 62 tasks from Wei et al. (2021) and 26 new tasks added for the present implementations, including dialog data (Byrne et al., 2019; Anantha et al., 2021; Dai et al., 2022) and program synthesis data (Yasunaga and Liang, 2020; Li et al., 2022). T0-SF (193 tasks) includes tasks from TO (Sanh et al., 2021) that do not overlap with the data used in Muffin (SF stands for “sans Flan”). NIV2 (1554 tasks) includes tasks from Wang et al. (2022c). Notably, 44 tasks related to MMLU (Hendrycks et al., 2020) were removed from NIV2, since MMLU is used for evaluation.

The fourth finetuning data mixture (reasoning) involves CoT annotations, which are used to illustrate how finetuning on CoT annotations improves performance on unseen reasoning tasks. A new mixture of nine datasets from prior work is created by collecting CoT annotations for a training corpus. The CoT annotations were collected by requesting human annotators to review training examples and provide descriptions of step-by-step reasoning that starts from the query and leads to the response. The nine datasets include tasks such as arithmetic reasoning (Cobbe et al., 2021), multi-hop reasoning (Geva et al., 2021), and natural language inference (Camburu et al., 2020). Ten instruction templates were used per task.

For Muffin, TO-SF, and NIV2, instructional templates for each task were used as given by the creators of the mixtures. A few example templates are illustrated as follows for an training dataset relating to entailment task categories:

### Template 1

<premise>
Based on the paragraph above, can we conclude that <hypothesis>?
<options>

### Template 2

<premise>
Can we infer the following?
<hypothesis>
<options>

### Template 3

Read the following and determine if the hypothesis can be inferred from the premis:
Premise: <premise>
Hypothesis: <hypothesis>
<options>

For CoT, ten instruction templates were newly created for each of the nine datasets. To create few-shot templates, a variety of exemplar delimiters (e.g., “Q:”/“A:”) were used by applying them randomly at the example level.

Instruction finetuning was applied across a broad range of model families, including T5 (Raffel et al., 2020), PaLM (Chowdhery et al., 2022), and U-PaLM (Tay et al., 2022b). These model families span a range of sizes, from Flan-T5-small (80M parameters), to PaLM and U-PaLM (540B parameters). For each model, the same training procedure is applied, except for a few hyperparameters: learning rate, batch size, dropout, and finetuning steps. The JAX-based T5X framework is used (Bradbury et al., 2018; Roberts et al., 2022).

The present examples use a constant learning rate schedule and finetune using the Adafactor optimizer (Shazeer and Stern, 2018). The present examples use packing (Raffel et al., 2020) to combine multiple training examples into a single sequence, separating inputs from targets using an end-of-sequence token. Masking is applied to prevent the tokens from attending to others across the packed example boundary.

Table 1 lists hyperparameter values for all finetuned models studied in these examples. The reported batch size is the global batch size (not per-device batch size).

TABLE 1
Hyperparameters used for all finetuned
models in this example results section.

| Params | Model | Batch size | Dropout | LR | Steps |
|---|---|---|---|---|---|
| 80M | Plan-T5-Small | 64 | 0.05 | 5e−4 | 98k |
| 250M | Flan-T5-Base | 64 | 0.05 | 5e−4 | 84k |
| 780M | Flan-T5-Large | 64 | 0.05 | 5e−4 | 64k |
| 3B | Plan-T5-XL | 64 | 0.05 | 5e−4 | 38k |
| 11B | Flan-T5-XXL | 64 | 0.05 | 5e−4 | 14k |
| 8B | Flan-PaLM | 32 | 0.05 | 3e−3 | 40k |
| 62B | Fan-PaLM | 32 | 0.05 | 3e−3 | 40k |
| 540B | Plan-PaLM | 32 | 0.1 | 1e−3 | 21k |
| 62B | Flan-cont-PaLM | 32 | 0.05 | 3e−3 | 60k |
| 540B | Flan-U-PaLM | 32 | 0.1 | 1e−3 | 30k |

For each model, a single checkpoint is used for all evaluations; the selected step was chosen based on periodic evaluations (every 2k to 10k steps depending the model size) of the held-out tasks. The same number of checkpoint steps were used across all ablation runs for a given model.

Notably, for the present examples, the amount of compute used for finetuning is only a small fraction relative to the training compute, as shown in Table 2. For example, only 0.2% of the pre-training compute was used to instruction-finetune Flan-PaLM 540B (approximately 512 v4 TPU chips for 37 hours).

TABLE 2
Across several models, instruction finetuning for the present examples only costs a small amount
of compute relative to pre-training. T5: Raffel et al. (2020). PaLM and cont-PaLM (also known
as PaLM 62B at 1.3 T tokens): Chowdhery et al. (2022). U-PaLM: Tay et al. (2022b).

| | | | Pre-training | Pre-train | Finetune | % Finetune |
|---|---|---|---|---|---|---|
| Params | Model | Architecture | Objective | FLOPs | FLOPs | Compute |
| 80M | Flan-T5-Small | encoder-decoder | span corruption | 1.8E+20 | 2.9E+18 | 1.6% |
| 250M | Flan-T5-Base | encoder-decoder | span corruption | 6.6E+20 | 9.1E+18 | 1.4% |
| 780M | Flan-T5-Large | encoder-decoder | span corruption | 2.3E+21 | 2.4E+19 | 1.1% |
| 3B | Flan-T5-XL | encoder-decoder | span corruption | 9.0E+21 | 5.6E+19 | 0.6% |
| 11B | Flan-T5-XXL | encoder-decoder | span corruption | 3.3E+22 | 7.6E+19 | 0.2% |
| 8B | Flan-PaLM | decoder-only | causal LM | 3.7E+22 | 1.6E+20 | 0.4% |
| 62B | Flan-PaLM | decoder-only | causal LM | 2.9E+23 | 1.2E+21 | 0.4% |
| 540B | Flan-PaLM | decoder-only | causal LM | 2.5E+24 | 5.6E+21 | 0.2% |
| 62B | Flan-cont-PaLM | decoder-only | causal LM | 4.8E+23 | 1.8E+21 | 0.4% |
| 540B | Flan-U-PaLM | decoder-only | prefix LM + span corruption | 2.5E+23 | 5.6E+21 | 0.2% |

Within the four mixtures (Muffin, TO-SF, NIV2, and CoT), the number of examples was used as the weight of each task. The maximum cap was applied for each task because there are tasks that are much larger than others in the same mixture, which can dominate the sampling. For example, some WMT translation datasets have millions of examples compared to BoolQ, which has 9k examples. A different maximum cap was applied for each of the four mixtures summarized in Table 3.

TABLE 3
Maximum example cap and proportion rates applied to the underlying
mixtures. Proportion A was used in scaling and the ablation
sections in Section 3 and Section 4. The rest of the experiments
used Proportion B, since Proportion A signaled that the
T0 mixture was good for performance.

| Mixture | Maximum cap | Proportion (A) | Proportion (B) |
|---|---|---|---|
| Muffin | 30,000 | 52% | 46.0% |
| T0-SF | 20,000 | 15% | 27.9% |
| CoT | 100,000 | 3% | 1.8% |
| NIV2 | 5,000 | 30% | 24.2% |

For balancing the four mixtures, the relative weights are used, ensuring that none of the underlying tasks is repeated more than once. For the scaling and ablation experiments in Section 3 and Section 4, respectively, the mixture proportions in Table 3, Proportion A were used. Based on these experiments (specifically, strong gains from TO-SF), the mixture proportions were updated to the Proportion B values in Table 3 for finetuning the rest of the models.

An overview of data sources are provided in Table 4. All data sources are publicly available. All MMLU tasks were removed from Natural Instructions to preserve its role as a broad benchmark of 57 held-out tasks for evaluation. In total, there are 1,836 tasks.

TABLE 4
Collections and individual datasets used in instruction finetuning.

| | | |
|---|---|---|
| Source Mixture | Task Name | Reference |

Collections

| | | |
|---|---|---|
| Muffin | FLAN | Wei et al. (2021) |
| T0-SF | T0 | Sanh et al. (2021) |
| Natural Instructions v2 | Natural Instructions | Wang et al. (2022c) |

Individual Datasets

| | | |
|---|---|---|
| Muffin | QReCC | Anantha et al. (2021) |
| Muffin | Task Master | Byrne et al. (2019) |
| Muffin | Wiki Dialog | Dai et al. (2022) |
| Muffin | Dr Repair - Error Comments | Yasunaga and Liang (2020) |
| Muffin | Dr Repair - Line Numbers | Yasunaga and Liang (2020) |
| Muffin | Dr Repair - No Errors | Yasunaga and Liang (2020) |
| Muffin | Dr Repair - Plain Code | Yasunaga and Liang (2020) |
| Muffin | DeepMind Coding Contents | Yasunaga and Liang (2020) |
| Muffin | Lambada | Paperno et al. (2016) |
| Muffin | UnifiedQA | Khashabi et al. (2020) |
| Reasoning | GSM8k | Cobbe et al. (2021) |
| Reasoning | StrategyQA | Geva et al. (2021) |
| Reasoning | AQuA | Ling et al. (2017) |
| Reasoning | Creak | Onoe et al. (2021) |
| Reasoning | ECQA | Aggarwal et al. (2021) |
| Reasoning | ESNLI | Camburu et al. (2018) |
| Reasoning | QASC | Khot et al. (2020) |
| Reasoning | QED | Lamm et al. (2021) |
| Reasoning | SenseMaking | Wang et al. (2019b) |

There are a total of 74,730 examples in the CoT mixture: AQUA (2,715), CREAK (6,910), ECQA (7,110), ESNLI (36,170), GSM8K (7,470), QASC (1,080), QED (5,145), Sensemaking (6,070), StrategyQA (2,060).

Evaluation was based on performance on held-out tasks which were not included as part of the finetuning data. The following challenging benchmarks were used, for which current language models still perform well below expert human raters.

(1) MMLU (Hendrycks et al., 2020) includes exam questions from 57 tasks such as mathematics, history, law, and medicine.

(2) BBH includes 23 challenging tasks from BIG-Bench (Srivastava et al., 2022) for which PaLM performs below an average human rater (Suzgun et al., 2022).

(3) TyDiQA (Clark et al., 2020) is a question-answering benchmark across 8 typologically diverse languages.

(4) MGSM (Shi et al., 2022) is a multilingual benchmark of math word problems from Cobbe et al. (2021) manually translated into 10 languages. These benchmarks were also used in the PaLM paper (Chowdhery et al., 2022), which did not find any meaningful data contamination with pre-training data, consistent with data contamination analyses in previous work (Brown et al., 2020; Wei et al., 2021; Du et al., 2022).

For MMLU and BBH, the present tests evaluated both the ability to directly predict the answer via direct prompting, where the model directly gives the answer (Brown et al., 2020; Srivastava et al., 2022), as well as via chain-of-thought (CoT) prompting, where the model must provide a reasoning chain before giving the final answer (Wei et al., 2022b). For TyDiQA, the present tests only measure direct prompting exact-match score, since highlighting the portion of a passage with the correct answer may not require sophisticated reasoning. For MGSM, the present tests only measure CoT prompting accuracy since direct prompting can have very low performance. For all benchmarks the present tests use the given few-shot exemplars, with the number of exemplars following prior work: five-shot for MMLU, three-shot for BBH, one-shot for TyDiQA, and 8-shot for MGSM. For a given model the present tests also report a single “normalized average” metric, following the “normalized preferred metric” in BIG-Bench (Srivastava et al., 2022). The normalized metric scales an evaluation number with respect to a task-specific lower bound such as random guessing baseline for a multiple choice question. For example, if random guessing produces 50% accuracy and the max accuracy of 100%, then a raw accuracy of 55% would be normalized to 10%, and a raw accuracy of 45% would be normalized to −10% since it is worse than random. The present normalized average metric is the macro-average over six normalized scores: MMLU-Direct, MMLU-COT, BBH-Direct, BBH-CoT, TyDiQA-Direct, and MGSM-CoT.

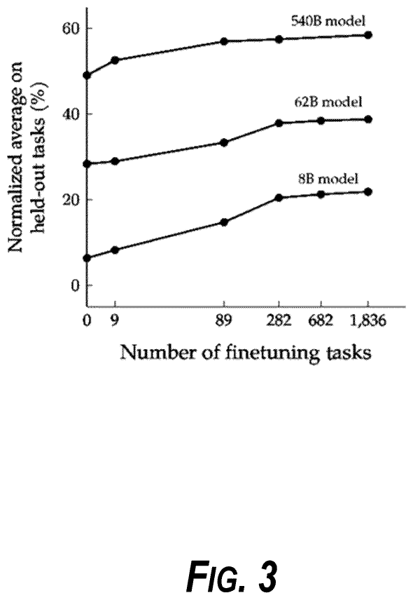

The present tests first examined the effect of scaling in terms of (1) the size of model and (2) the number of finetuning tasks on performance on held-out tasks. The present tests scale the model size by performing experiments on three PaLM model sizes: 8B, 62B, and 540B. To scale the number of tasks, the present tests sequentially add task mixtures starting from the mixture with the fewest tasks to the mixture with the most tasks: CoT, Muffin, T0-SF, and NIV2. FIG. 3 shows the effect of scaling. Individual benchmark results are reported in Table 5.

TABLE 5
Increasing the number of tasks in the finetuning data improves performance of Flan-PaLM on most
evaluation benchmarks. The benchmark suites are MMLU (57 tasks), BBH (23 tasks), TyDiQA (8 languages),
and MGSM (10 languages). The evaluation metric on all four benchmark suites is few-shot prompted
accuracy (exact match), based on an unweighted average over all tasks. As an aggregate metric
the normalized average of MMLU-direct, MMLU-CoT, BBH-direct, BBH-CoT, TyDiQA, and MGSM is reported.
These evaluation benchmarks are held-out (not included in the finetuning data)

| | | | | | MMLU | | BBH | | TyDiQA | MGSM |
|---|---|---|---|---|---|---|---|---|---|---|
| Model | Finetuning Mixtures | Tasks | Norm. avg. | | Direct | CoT | Direct | CoT | Direct | CoT |
| 8B | None (no finetuning) | 0 | 6.4 | | 24.3 | 24.1 | 30.8 | 30.1 | 25.0 | 3.4 |
| | CoT | 9 | 8.3 | (+1.9) | 26.3 | 32.1 | 19.8 | 26.6 | 39.3 | 10.4 |
| | CoT, Muffin | 89 | 14.8 | (+8.4) | 37.6 | 38.4 | 31.0 | 30.9 | 32.4 | 8.4 |
| | CoT, Muffin, T0-SF, NIV2 | 282 | 20.5 | (+14.1) | 47.7 | 39.7 | 33.1 | 30.9 | 49.0 | 8.5 |
| | CoT, Muffin, T0-SF, NIV2 | 1,836 | 21.9 | (+15.5) | 49.3 | 41.3 | 36.4 | 31.1 | 47.5 | 8.2 |
| 62B | None (no finetuning) | 0 | 28.4 | | 55.1 | 49.0 | 37.4 | 43.0 | 40.5 | 18.2 |
| | CoT | 9 | 29.0 | (+0.4) | 48.5 | 48.7 | 34.5 | 39.5 | 48.8 | 32.6 |
| | CoT, Muffin | 89 | 33.4 | (+6.0) | 55.3 | 51.4 | 42.8 | 40.2 | 53.0 | 23.9 |
| | CoT, Muffin, T0-SF | 282 | 37.9 | (+9.5) | 60.0 | 56.0 | 44.7 | 43.8 | 58.2 | 30.0 |
| | CoT, Muffin, T0-SF, NIV2 | 1,836 | 38.8 | (+10.4) | 59.6 | 56.9 | 47.5 | 44.9 | 58.7 | 28.5 |
| 540B | None (no finetuning) | 0 | 49.1 | | 71.3 | 62.9 | 49.1 | 63.7 | 52.9 | 45.9 |
| | CoT | 9 | 52.6 | (+3.5) | 68.8 | 64.8 | 50.5 | 61.1 | 61.2 | 59.4 |
| | CoT, Muffin | 89 | 57.0 | (+7.9) | 71.8 | 66.7 | 56.7 | 64.0 | 65.3 | 63.0 |
| | CoT, Muffin, T0-SF | 282 | 57.5 | (+8.4) | 72.9 | 68.2 | 57.3 | 64.0 | 65.8 | 61.6 |
| | CoT, Muffin, T0-SF, NIV2 | 1,836 | 58.5 | (+9.4) | 73.2 | 68.1 | 58.8 | 65.6 | 67.4 | 61.3 |

For all three model sizes shown, multi-task instruction finetuning improves performance by a large margin compared to no finetuning. The performance gain ranges from 9.4% to 15.5%. Second, increasing the number of finetuning tasks improves performance, although the majority of the improvement comes from using up to 282 tasks. Two potential explanations for the small gain after 282 tasks: One is that the additional tasks are not particularly diverse, and so they are not providing the model with new knowledge. Another explanation is that most of the gains from multi-task instruction finetuning come from the model learning to better express knowledge that it already knows from pretraining, and more than 282 tasks does not help too much. This second explanation could make sense since the pre-training data consists of 780B tokens, while instruction finetuning only uses 1.4B tokens (0.2% of the pre-training tokens). Finally, the present tests show that increasing model scale by an order of magnitude (i.e., 8B→62B or 62B→540B) improves performance substantially for both finetuned and non-finetuned models.

The present tests first show that including nine datasets with chain-of-thought (CoT) annotations in the finetuning mixture improves reasoning ability. Table 6 shows that CoT prompting abilities of Flan-PaLM outperform PaLM on the four held-out evaluation benchmarks. For BBH, the present tests follow the protocol of Suzgun et al. (2022) and stratify the tasks into NLP tasks and algorithmic tasks. Table 6 also shows how CoT prompting can be combined with self-consistency (SC; Wang et al., 2022b) to achieve new state-of-the-art performance on several benchmarks. For instance, on the MMLU benchmark (Hendrycks et al., 2020), Flan-PaLM 540B achieves 75.2%. This is a wide margin over prior models (PaLM=69.3%, code-davinci-002=68.3%, Chinchilla=67.6%). On the MGSM benchmark of multilingual math problems, Flan-PaLM with CoT+SC improves SOTA significantly, achieving high performance even on under-represented languages, such as 69.6% on Bengali. In comparison, PaLM with CoT+SC only achieves 63.6% with French and 61.2% on German, which are high-resource languages. As a final result, on GSM8K (Cobbe et al., 2021, not shown in the table), Flan-PaLM with CoT+SC achieves a new state of the art of 83.9%, though note that the GSM8K training dataset is included in the instruction finetuning mixture.

TABLE 6
Flan-PaLM outperforms PaLM on all evaluation benchmarks.

| | MMLU | BBH-nlp | BBH-alg | TyDiQA | MGSM |
|---|---|---|---|---|---|
| Prior best | 69.3^{a} | 73.5^{b} | 73.9^{b} | 81.9^{c} | 55.0^{d} |
| PaLM 540B | | | | | |
| direct prompting | 69.3 | 62.7 | 38.3 | 52.9 | 18.3 |
| CoT prompting | 64.5 | 71.2 | 57.6 | — | 45.9 |
| CoT + self-consistency | 69.5 | 78.2 | 62.2 | — | 57.9 |
| Flan-PaLM 540B | | | | | |
| direct prompting | 72.2 | 70.0 | 48.2 | 67.8 | 21.2 |
| CoT prompting | 70.2 | 72.4 | 61.3 | — | 57.0 |
| CoT + self-consistency | 75.2 | 78.4 | 66.5 | — | 72.0 |

Prior best are the following.
^{a}PaLM without CoT prompting (Chowdhery et al., 2022).
^{b}Codex with CoT prompting but no self-consistency (code-davinci-002; Chen et al., 2021).
^{c}Finetuned ByT5 (Xue et al., 2022).
^{d}PaLM + Google translate API with CoT prompting but no self-consistency (Shi et al., 2022).
The MMLU results are on the test set.

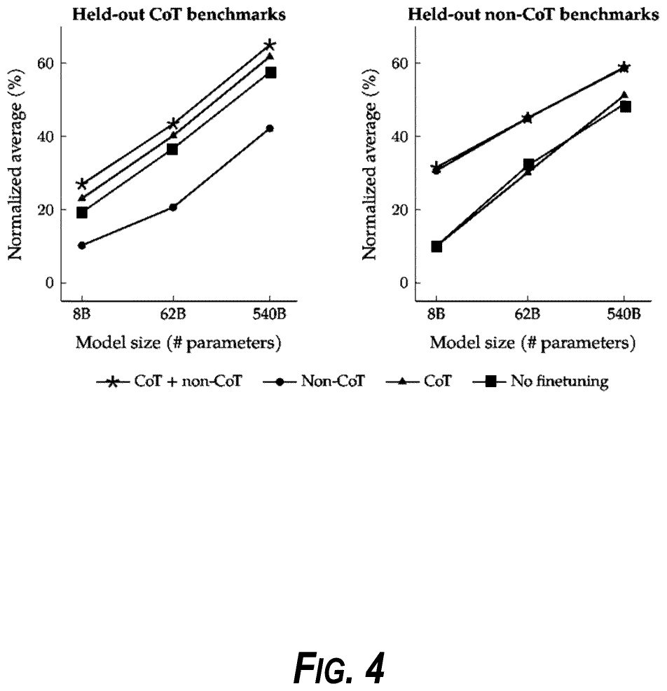

The present tests next ablate the effect of including just nine CoT datasets in instruction finetuning. The present tests stratify evaluations into held-out CoT benchmarks (MMLU, BBH, and MGSM) and held-out non-CoT benchmarks (MMLU, BBH, and TyDiQA) and compute normalized averages for CoT and non-CoT. In FIG. 4-left, performance on heldout CoT benchmarks is stronger with combined non-CoT and CoT finetuning than just CoT finetuning alone. FIG. 4-right confirms that finetuning on combined CoT and non-CoT does not compromise performance on non-CoT tasks compared to finetuning on non-CoT only

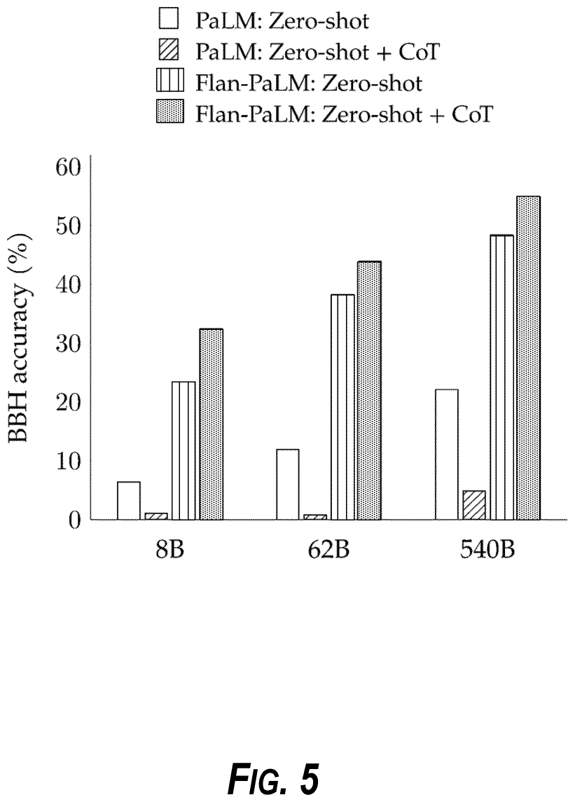

Another benefit of instruction finetuning on CoT data both with and without exemplars is that the resulting model is able to perform CoT reasoning in a zero-shot setting. This zero-shot setting tests the ability for the model to produce its own reasoning skills without few-shot exemplars for CoT, which can require substantial prompt engineering to compose properly. FIG. 5 shows that for the BBH benchmark of 23 unseen challenging BIG-Bench tasks, Flan-PaLM models can achieve improved performance by leveraging CoT reasoning activated by the phrase “let's think step-by-step” (Kojima et al., 2022). In comparison, PaLM without finetuning does not generate CoT that allows it to solve these problems.

The present tests now show the generality of instruction finetuning by applying it to several models of different sizes, architectures, and training objectives. In addition to the PaLM family of models, the present tests instruction-finetune T5 models which have an encoder-decoder architecture, as opposed to PaLM's decoder-only architecture. As an extended version of the PaLM 62B model, the present tests instruction-finetune cont-PaLM, which is a 62B PaLM-model initialized from PaLM-62B and then pretrained for 500B more tokens (Chowdhery et al., 2022). Finally, the present tests instruction-finetune U-PaLM, which is a 540B PaLM model initialized from PaLM-540B and then pretrained with an UL2 objective for 20k additional steps (Tay et al., 2022a,b). These evaluation results are shown in Table 7.

TABLE 7
Instruction finetuning (Flan) improves performance on top of other continued pre-
training methods. The benchmark suites are MMLU (57 tasks), BBH (23 tasks), TyDiQA
(8 languages), and MGSM (10 languages). The evaluation metric on all four benchmark
suites is few-shot prompted accuracy (exact match), where the present tests take
an unweighted average over all tasks. As an aggregate metric Table 7 reports the
normalized average of MMLU-direct, MMLU-CoT, BBH-direct, BBH-CoT, TyDiQA, and MGSM.
These evaluation benchmarks are held-out (not included in the finetuning data).

| | | | | MMLU | | BBH | | TyDiQA | MGSM |
|---|---|---|---|---|---|---|---|---|---|
| Params | Model | Norm. avg. | | Direct | CoT | Direct | CoT | Direct | CoT |
| 80M | T5-Small | −9.2 | | 26.7 | 5.6 | 27.0 | 7.2 | 0.0 | 0.4 |
| | Flan-T5-Small | −3.1 | (+6.1) | 28.7 | 12.1 | 29.1 | 19.2 | 1.1 | 0.2 |
| 250M | T5-Base | −5.1 | | 25.7 | 14.5 | 27.8 | 14.6 | 0.0 | 0.5 |
| | Flan-T5-Base | 6.5 | (+11.6) | 35.9 | 33.7 | 31.3 | 27.9 | 4.1 | 0.4 |
| 780M | T5-Large | −5.0 | | 25.1 | 15.0 | 27.7 | 16.1 | 0.0 | 0.3 |
| | Flan-T5-Large | 13.8 | (+18.8) | 45.1 | 40.5 | 37.5 | 31.5 | 12.3 | 0.7 |
| 3B | T5-XL | −4.1 | | 25.7 | 14.5 | 27.4 | 19.2 | 0.0 | 0.8 |
| | Flan-T5-XL | 19.1 | (+23.2) | 52.4 | 45.5 | 41.0 | 35.2 | 16.6 | 1.9 |
| 11B | T5-XXL | −2.9 | | 25.9 | 18.7 | 29.5 | 19.3 | 0.0 | 1.0 |
| | Flan-T5-XXL | 23.7 | (+26.6) | 55.1 | 48.6 | 45.3 | 41.4 | 19.0 | 4.9 |
| 8B | PaLM | 6.4 | | 24.3 | 24.1 | 30.8 | 30.1 | 25.0 | 3.4 |
| | Flan-PaLM | 21.9 | (+15.8) | 49.3 | 41.3 | 36.4 | 31.1 | 47.5 | 8.2 |
| 62B | PaLM | 28.4 | | 55.1 | 49.0 | 37.4 | 43.0 | 40.5 | 18.2 |
| | Flan-PaLM | 38.8 | (+10.4) | 59.6 | 56.9 | 47.5 | 44.9 | 58.7 | 28.5 |
| 540B | PaLM | 49.1 | | 71.3 | 62.9 | 49.1 | 63.7 | 52.9 | 45.9 |
| | Flan-PaLM | 58.4 | (+9.3) | 73.5 | 70.9 | 57.9 | 66.3 | 67.8 | 57.0 |
| 62B | cont-PaLM | 38.1 | | 61.2 | 57.6 | 41.7 | 53.1 | 45.7 | 32.0 |
| | Flan-cont-PaLM | 46.7 | (+8.6) | 66.1 | 62.0 | 51.0 | 53.3 | 62.7 | 40.3 |
| 540B | U-PaLM | 50.2 | | 71.5 | 64.0 | 49.2 | 62.4 | 54.6 | 49.9 |
| | Flan-U-PaLM | 59.1 | (+8.9) | 74.1 | 69.8 | 59.3 | 64.9 | 68.3 | 60.4 |

Instruction finetuning improves normalized average performance by a large margin for all model types. For T5 models without instruction finetuning, the present tests use LM-adapted models, which were produced by training T5 on 100B additional tokens from C4 on a standard language modeling objective (Lester et al., 2021). Given the difficulty of the evaluation benchmarks and the fact that T5 is not multilingual, T5 models benefited the most from instruction finetuning compared with their non-finetuned models. These results were quite strong for some benchmarks—for example, Flan-T5-XL is only 3B parameters and achieves a MMLU score of 52.4%, surpassing GPT-3 175B's score of 43.9%.

As another highlight, the strongest overall model the present tests achieved combines instruction finetuning with UL2 continued pre-training that was used in the U-PaLM model. This result shows that instruction finetuning and UL2 continued pre-training are complementary compute-efficient methods to improve the performance of language models without increasing model scale. Further details regarding U-PaLM are described in U.S. 63/305,910 (filed Feb. 2, 2022) and PCT/US2022/054370 (filed Dec. 30, 2022), which are both hereby incorporated by reference herein in their respective entireties.

Beyond the NLP benchmarks, language models are also capable of generating long-form answers to open-ended requests. Standard NLP benchmarks and the automatic metrics used to evaluate them are not always sufficient to measure human preferences among these open-form responses (Ouyang et al., 2022). Hence, the present tests conduct a manual evaluation that investigates the effect of instruction finetuning on the ability for models to give open-ended responses to challenging inputs. To do this, the present tests created an evaluation set of 190 examples. This evaluation set includes questions posed in a zero-shot manner to the model across five challenging categories of 20 questions each: creativity, reasoning over contexts, complex reasoning, planning, and explanation. For 60 of these examples (from the complex reasoning, planning, and explanation categories) the present tests used a variant with a chain-of-thought trigger phrase (e.g., “let's think step-by-step”), as another evaluation of whether finetuning on CoT enables zero-shot, which was quantitatively evaluated above. In addition to the above 160 zero-shot inputs, the present tests include 30 inputs testing few-shot capabilities, which strong language models without instruction finetuning have been shown to do well on (Chowdhery et al., 2022). In this evaluation the present tests compare the PALM 540B and Flan-PaLM 540B models. For both models, the present tests use temperature sampling with τ=0.7 to generate five responses randomly, and then rank them by log probability score without length normalization. The present tests choose the response with the best score, after a filtering step of removing any generations with scores that were better than half of the median score, which the present tests found successfully removed a large portion of generations with undesirable repetitions. For example, if the median log probability score of five generations is −20, then a generation with a score of −3 would likely have undesirable repetitions and the present tests filter it out. The present tests then present the PALM and Flan-PaLM outputs to human raters and ask them to choose the responses based on desirability. Each pair of outputs is scored by one rater.

The annotation instructions for the human evaluation are provided here:
We have collected responses from different large language models to questions requiring various forms of reasoning. We would like you to help us rank these responses. Each prompt you see will come with responses from (anonymous) large language models, which have been shuffled on EACH ROW, so you the annotator cannot know which model they come from. PLEASE READ THESE INSTRUCTIONS IN FULL.
Annotation Rules:
   Rank the responses according to which one provides the best answer to the input prompt.
   What is the best answer? Make a decision based on (a) the correctness of the answer, and (b) the informativeness of the response. For (a) you are allowed to search the web. Overall, use your best judgment to rank answers based on being the most useful response, which we define as one which is at least somewhat correct, and minimally informative about what the prompt is asking for.
   If two responses provide the same correctness and informativeness by your judgment, and there is no clear winner, you may rank them the same, but please only use this sparingly.
   If the answer for a given response is nonsensical, irrelevant, highly ungrammatical/confusing, or does not clearly respond to the given prompt, label it with “F” (for fail) rather than its rank.
   Long answers are not always the best. Answers which provide succinct, coherent responses may be better than longer ones, if they are at least as correct and informative.

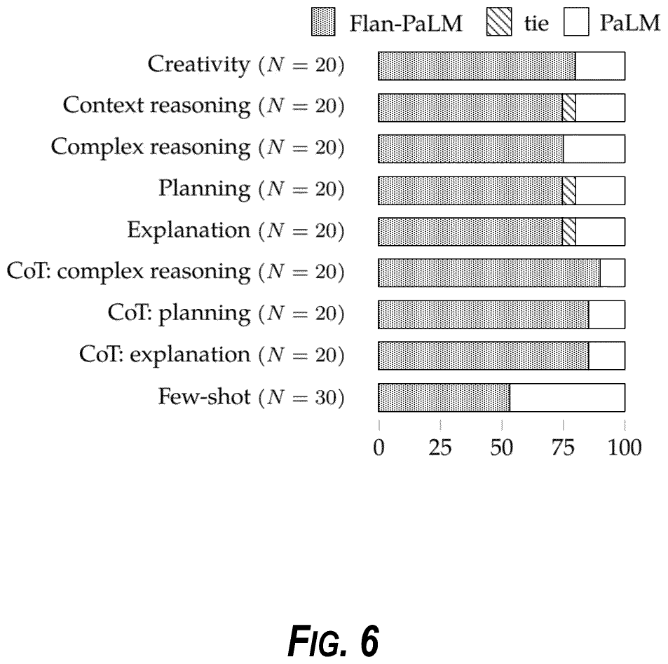

The results of this human evaluation are shown in FIG. 6-across 190 examples, Flan-PaLM generations were preferred 79% of the time. For every zero-shot setting, FlanPaLM was preferred by a large margin, and for inputs that used a CoT trigger phrase, the rater preference for Flan-PaLM over PaLM further increased by around 10%. As for fewshot, there was no regression compared to PaLM.

### Example Methods

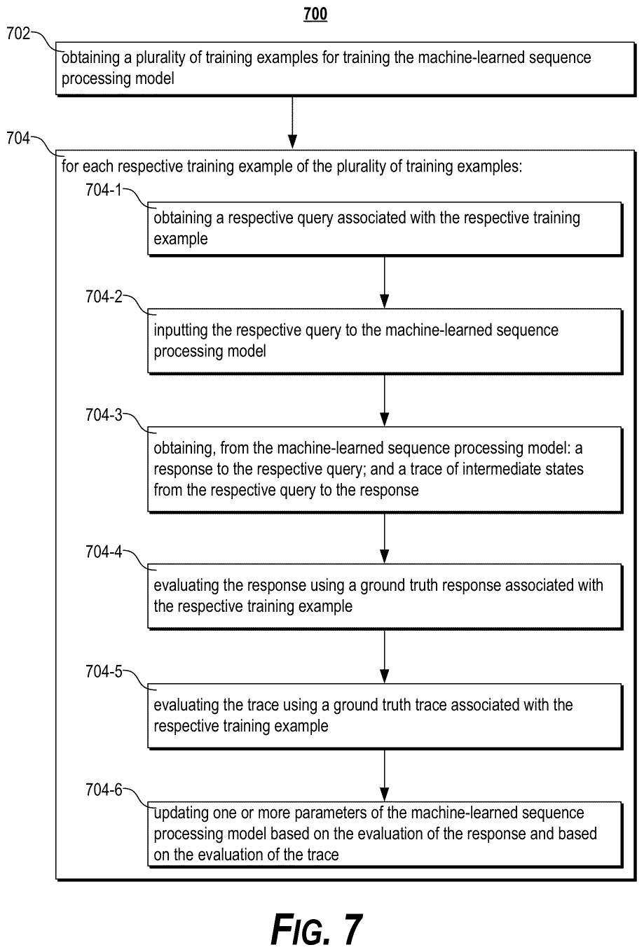

FIG. 7 depicts a flowchart of a method 700 for training one or more machine-learned models according to aspects of the present disclosure. For instance, an example machine-learned model can include a machine-learned model 100.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining a plurality of training examples for training the machine-learned sequence processing model. In some implementations, each training example of the plurality of training examples includes an example query, an example response to the query, and an example trace of intermediate states from the example query to the example response. For example, the training examples can include example chain-of-thought data describing reasoning steps used to logically proceed from the query to the response.

At 704, example method 700 can perform one or more operations for each respective training example of the plurality of training examples to train the machine-learned sequence processing model. These operations can include processing the respective query through the model to generate a predicted response and a predicted trace of intermediate states, which are then compared against the ground truth response and trace provided in the training example. The predicted response can be the model's direct answer to the query, while the predicted trace details the model's reasoning process leading to that answer. The comparison between the predicted and ground truth elements can be used to calculate a loss or error metric to quantify the model's performance. Based on this metric, the parameters of the model can be adjusted to minimize the loss (or inversely, to increase a score). The operations can be iteratively performed across the training examples, allowing the model to learn from a wide array of problem-solving strategies and reasoning patterns.

For example, at 704-1, example method 700 can include obtaining a respective query associated with the respective training example. Operation 704-1 can involve the computing system identifying and extracting the query component from each training example, which serves as the initial input for the machine-learned sequence processing model. The query can take various forms, such as a question in natural language, a set of instructions for a task, or a problem statement requiring a solution. The nature of the query may vary depending on the application domain, ranging from simple factual questions to complex scenarios requiring multi-step reasoning. For instance, the query could be a math problem in an educational dataset, a diagnostic question in a medical dataset, or a customer inquiry in a customer service dataset. The computing system can employ parsing techniques to accurately extract the query from structured or unstructured data sources, ensuring that the model receives the correct input for training. Additionally, the system can preprocess the query to conform to the input format expected by the model.

For example, at 704-2, example method 700 can include inputting the respective query to the machine-learned sequence processing model. The inputting process can involve preprocessing steps such as tokenizing query data, embedding the tokens, etc. Inputting can include directly passing the data to a locally executing instance of the model. Inputting can include packaging the data into one or more network-transmitted messages to communicate with an API endpoint associated with a computing system on which the model is executing.

For example, at 704-3, example method 700 can include obtaining, from the machine-learned sequence processing model, a response to the respective query and a trace of intermediate states from the respective query to the response. This can involve the computing system retrieving the output generated by the model after processing the input query. The response can represent the model's conclusion or answer to the query, which can range from a simple classification label to a complex narrative or calculated result. The trace can provide a detailed account of the intermediate steps that the model employed to arrive at the response. For example, in educational settings, the trace can show the steps a model took to solve a math problem, while in medical diagnostics, it can outline the symptoms and medical knowledge the model considered to reach a diagnosis. This dual output of response and trace can be used to refine the model's training updates, as it not only validates the final answer but also the logical path taken to achieve it.

For example, at 704-4, example method 700 can include evaluating the response using a ground truth response associated with the respective training example. For example, a supervised training computing system (e.g., system 130) can compare the generated response with a ground truth response. The comparison can involve evaluating probability assigned by the model to the tokens of the ground truth response (e.g., in an output layer of the model from which the response is sampled). A method for evaluating the response includes a cross-entropy loss that measures the difference between the predicted probability distribution generated by the model and the actual distribution represented by the ground truth. The cross-entropy loss can be normalized by the sequence length to account for variations in the length of responses to help ensure that the model's performance is not biased towards shorter or longer sequences.

For example, at 704-5, example method 700 can include evaluating the trace using a ground truth trace associated with the respective training example. This can involve assessing the sequence of intermediate states or reasoning steps the model has generated against a benchmark set of steps that are known to be correct. The ground truth trace, which can be curated by subject matter experts, can illustrate a ground truth reasoning process that leads to the correct response. By comparing the model-generated trace to the ground truth trace, the computing system can identify areas where the model's reasoning diverges from the reference logic. The evaluation can be performed using various metrics, such as edit distance for sequential data or a more sophisticated alignment algorithm that accounts for the semantic content of the trace. The goal can be to minimize the discrepancy between the generated trace and the ground truth (e.g., increase a likelihood of generating the ground truth trace). Through this evaluation, the model can learn to not only produce correct answers but also to articulate the reasoning behind those answers in a way that aligns with human logic and understanding. Especially for applications using autoregressive generation, training the model to explicitly reason over the response to the query can provide stronger and more confident signals for arriving at the desired response.

In some implementations, the ground truth trace can be obtained from annotations that were input by a human user after being presented with the query and the ground truth response. For example, the annotations can include a description of step-by-step reasoning between the respective query and the ground truth response. This human-annotated trace serves as a rich source of information for the model, providing a detailed and logical explanation of an example thought process that leads to the answer. These annotations can be written by domain experts or other human users. The annotations can cover a wide range of reasoning types, such as deductive, inductive, and analogical reasoning, thus equipping the model with a comprehensive set of examples to learn from. By training with these human-annotated traces, the machine-learned sequence processing model can develop an improved understanding of how to approach complex queries.

An example technique for soliciting ground truth traces from human annotators involves a structured annotation process. An annotation computing system can provide human annotators with a series of queries and corresponding responses. The annotation computing system can render a prompt that asks the annotators to articulate the reasoning steps that connect a given query with a given response.

For instance, an annotation computing system can present the annotator with a mathematical problem (the query) and its solution (the response). The annotation computing system can prompt the annotator to document each intermediate mathematical operation required to arrive at the solution. The platform can provide tools for the annotator to input equations, text explanations, or diagrams as part of their trace. Additionally, the annotation computing system may include features such as suggesting relevant knowledge or common reasoning patterns to help the annotator construct a coherent and logical trace.

In another example, for tasks involving natural language understanding, the annotators might be asked to highlight and annotate the key pieces of text from a given passage that led them to a particular inference or conclusion. They could also be prompted to write out the logical deductions or connections they made in their own words, creating a narrative that explains their thought process.

To improve the quality of the ground truth traces, the annotation process can include a review stage, where multiple experts evaluate and potentially revise each trace for accuracy and clarity. Moreover, the annotation computing system can collect metadata about the annotators' interactions, such as time spent on each task or the use of help resources, to further refine the process and the training data quality. Annotation systems can also employ gamification elements to engage and motivate the annotators, such as scoring systems, progress tracking, and rewards for high-quality contributions.

For example, at 704-6, example method 700 can include updating one or more parameters of the machine-learned sequence processing model based on the evaluation of the response and based on the evaluation of the trace. For example, a loss or score can be computed based on the respective evaluations. Updates to the parameters of the machine-learned sequence processing model can involve adjusting parameters (e.g., weights, etc.) within the model's architecture to decrease the loss (or increase a score). For instance, the loss can be backpropagated through the model. The magnitude and direction of the parameter updates can be determined based on a gradient of the loss with respect to each parameter. The updates are applied iteratively over multiple epochs or training cycles.

In some implementations of example method 700, the plurality of training examples includes examples from multiple different task categories. Task categories can encompass a wide range of domains such as natural language processing, computer vision, speech recognition, and more specialized fields like medical diagnosis or financial forecasting. Further examples are described above. The task categories can also be designed to cover different types of reasoning and problem-solving strategies.

In some implementations of example method 700, the task categories include at least one or more of: question generation; explanation generation; or question and answer generation.

In some implementations of example method 700, the respective training example is associated with a particular task determined by selecting a dataset; selecting a task category; selecting an instruction template associated with the task category; and populating the instruction template using data from the dataset to obtain the respective query of the respective training example. In this manner, for example, numerous diverse training examples can be generated in a structured manner. For example, a dataset can provide a pairing of an input subject matter and output subject matter (e.g., a hypothesis and a premise, a question and an answer, etc.). A task category can include, for instance, a question generation task, an entailment task, etc. The combination of a dataset and a task category can provide an individual task. Individual tasks can be formatted using a plurality of different templates.

For example, for an entailment task, example templates can include:

### Template 1

<premise>
Based on the paragraph above, can we conclude that <hypothesis>?
<options>

### Template 2

<premise>
Can we infer the following?
<hypothesis>
<options>

### Template 3

Read the following and determine if the hypothesis can be inferred from the premise:
Premise: <premise>
Hypothesis: <hypothesis>
<options>

In some implementations of example method 700, instruction templates can be varied and randomized during training to prevent the model from relying too heavily on specific cues or formats.

In some implementations of example method 700, the instruction template is configured to induce the machine-learned sequence processing model to generate traces when generating responses to input queries. The instruction template can be designed with specific prompts or placeholders that signal to the model to insert a reasoning trace. For instance, a template for a math problem might include example steps for calculation, while a template for a legal reasoning task might include sections for argument construction.

In some implementations of example method 700, the instruction template is selected from a plurality of instruction templates.

In some implementations of example method 700, the plurality of instruction templates includes at least ten instruction templates.

In some implementations of example method 700, populating the instruction template includes: populating the instruction template with one or more exemplar delimiters selected randomly from a plurality of exemplar delimiters.

In some implementations, example method 700 includes training the machine-learned sequence processing model using other training examples without ground truth traces (e.g., direct responses only). For example, training examples with ground truth traces can be a fractional proportion of a total number of training examples used in finetuning. In some implementations of example method 700, the plurality of training examples (e.g., the training examples that are associated with ground truth traces) are less than ten percent of the sum of a quantity of the plurality of training examples and a quantity of the other training examples without ground truth traces. In some implementations of example method 700, the plurality of training examples (e.g., the training examples that are associated with ground truth traces) are less than five percent of the sum of a quantity of the plurality of training examples and a quantity of the other training examples without ground truth traces. In some implementations of example method 700, the plurality of training examples (e.g., the training examples that are associated with ground truth traces) are less than 4 percent of the sum of a quantity of the plurality of training examples and a quantity of the other training examples without ground truth traces. In some implementations of example method 700, the plurality of training examples (e.g., the training examples that are associated with ground truth traces) are less than 3 percent of the sum of a quantity of the plurality of training examples and a quantity of the other training examples without ground truth traces. In some implementations of example method 700, the plurality of training examples (e.g., the training examples that are associated with ground truth traces) are less than 2 percent of the sum of a quantity of the plurality of training examples and a quantity of the other training examples without ground truth traces. In some implementations of example method 700, the plurality of training examples (e.g., the training examples that are associated with ground truth traces) are less than 1 percent of the sum of a quantity of the plurality of training examples and a quantity of the other training examples without ground truth traces.

In some implementations of example method 700, the respective query includes an exemplar query, an exemplar trace, and an exemplar response. For example, the query can provide a single or few-shot prompt that illustrates the desired pattern of generating a trace in support of a response.

In some implementations of example method 700, the respective query does not include an exemplar trace. For example, the query can require zero-shot generation of the trace. For instance, the query can include a specific instruction to generate a trace, such as the phrase “let's think step-by-step.”

In some implementations of example method 700, the response and the trace are generated in a single forward pass of the machine-learned sequence processing model.

In some implementations of example method 700, the query includes an instruction, and wherein the one or more parameters are updated to increase a likelihood that the machine-learned sequence processing model generates an output that follows the instruction. For example, a loss function can measure not only the accuracy of the response but also the adherence to the given instructions. For example, if the instruction requires a step-by-step explanation, the loss function can penalize outputs that do not provide a matching explanation.

In some implementations of example method 700, the trace includes a chain of intermediate responses to intermediate queries. Each intermediate query within the chain can represent a sub-problem or consideration that contributes to the final response. The model can generate intermediate responses that address these sub-problems, effectively breaking down complex tasks into manageable segments. This approach can be particularly beneficial for tasks that require deep reasoning or multi-step calculations, such as solving mathematical word problems, where each step builds upon the previous one.

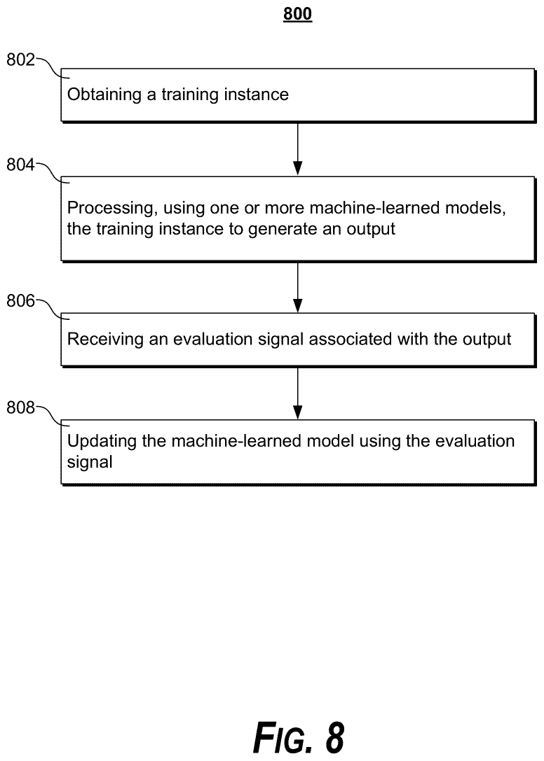

FIG. 8 depicts a flowchart of a method 800 for training one or more machine-learned models according to aspects of the present disclosure. For instance, an example machine-learned model can include a machine-learned model 100.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 9 is a block diagram of an example processing flow for using machine-learned model(s) 1 to process input(s) 2 to generate output(s) 3.

Machine-learned model(s) 1 can be or include any one of or any part of machine-learned models referenced with respect to any of the figures herein (e.g., models 100, 55, 65, etc.). For example, any one or multiple of machine-learned models 100, 55, 65 can be a machine-learned model 1. Features and variations described herein with respect to machine-learned model 1 are to be understood as describing features and variations of any of the machine-learned models described herein. Where this description references machine-learned model 1 it is to be understood that implementations of each of the other models described herein are implicitly referenced and represented thereby.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models that can cooperatively interact to process data from input(s) 2. For example, machine-learned model(s) 1 can employ a mixture-of-experts structure that routes input(s) through various component models that specialize in various aspects. See, e.g., Zhou et al., Mixture-of-Experts with Expert Choice Routing, ARXIV:2202.09368v2 (Oct. 14, 2022). Machine-learned model(s) 1 can include an ensemble of networks that can process an input to contribute different portions or aspects to an overall output.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

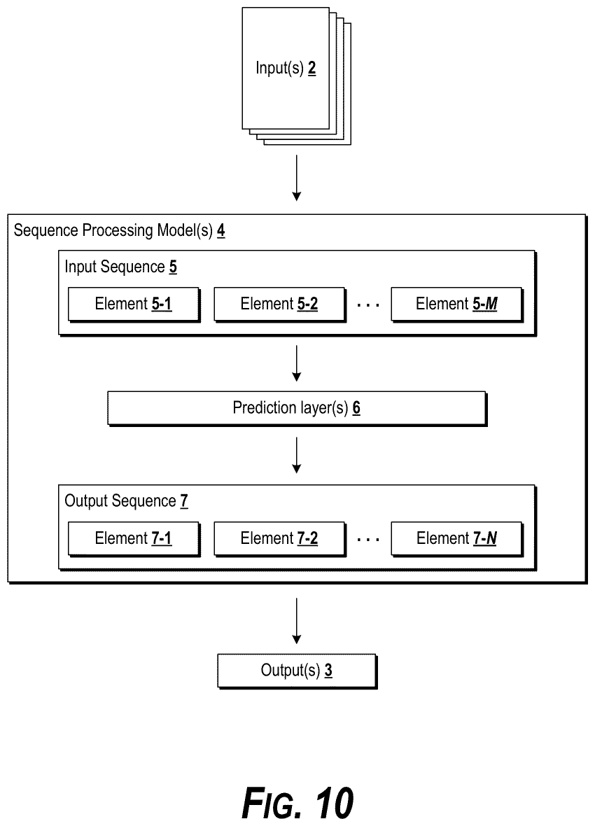

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

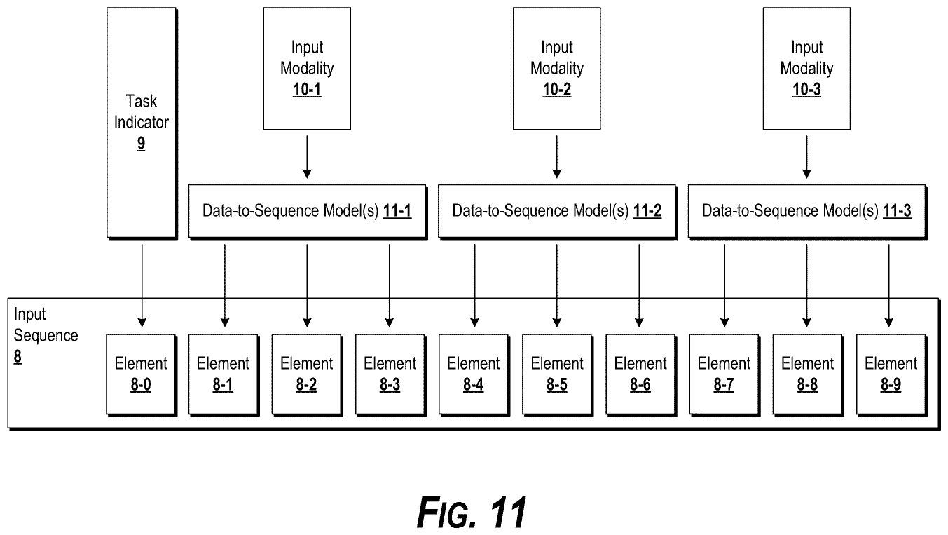

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

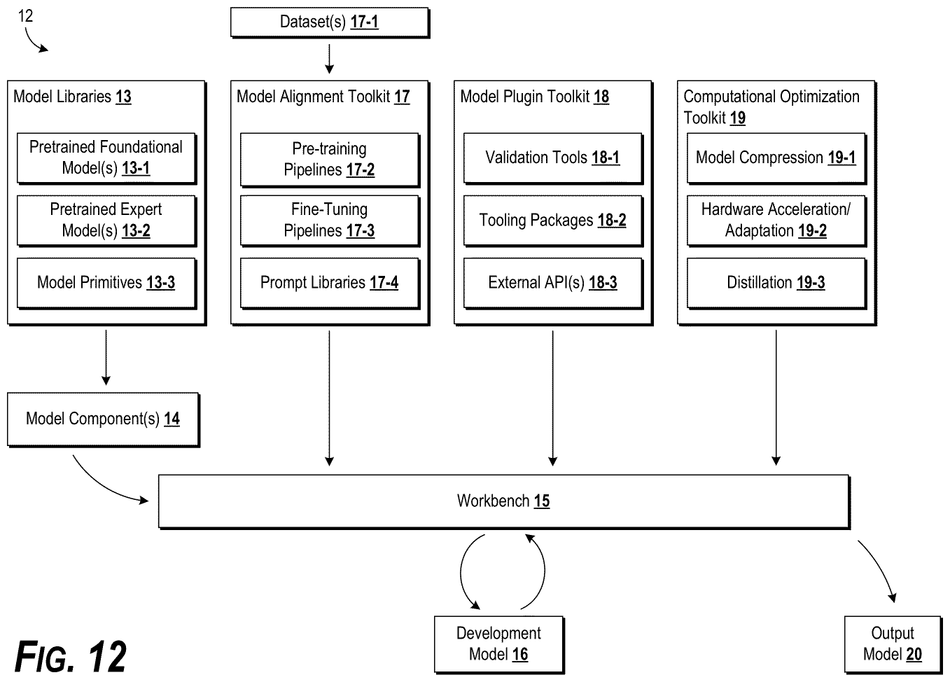

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Dataset(s) 17-1 can include data annotated with ground truth traces.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Fine-tuning pipelines 17-3 can include a model training component configured to fine-tune a model using data annotated with ground truth traces.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

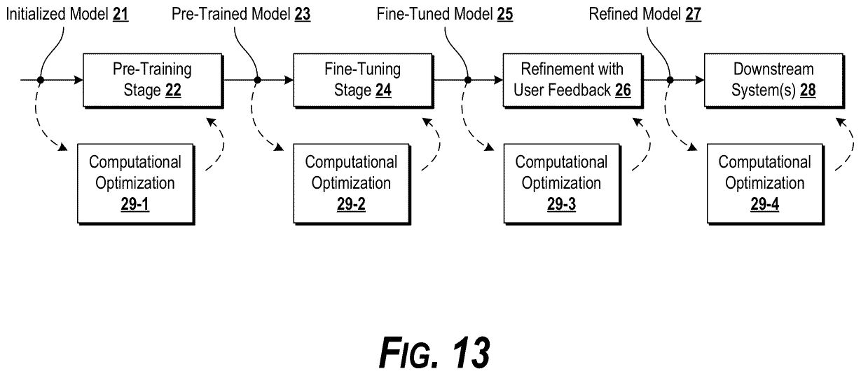

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

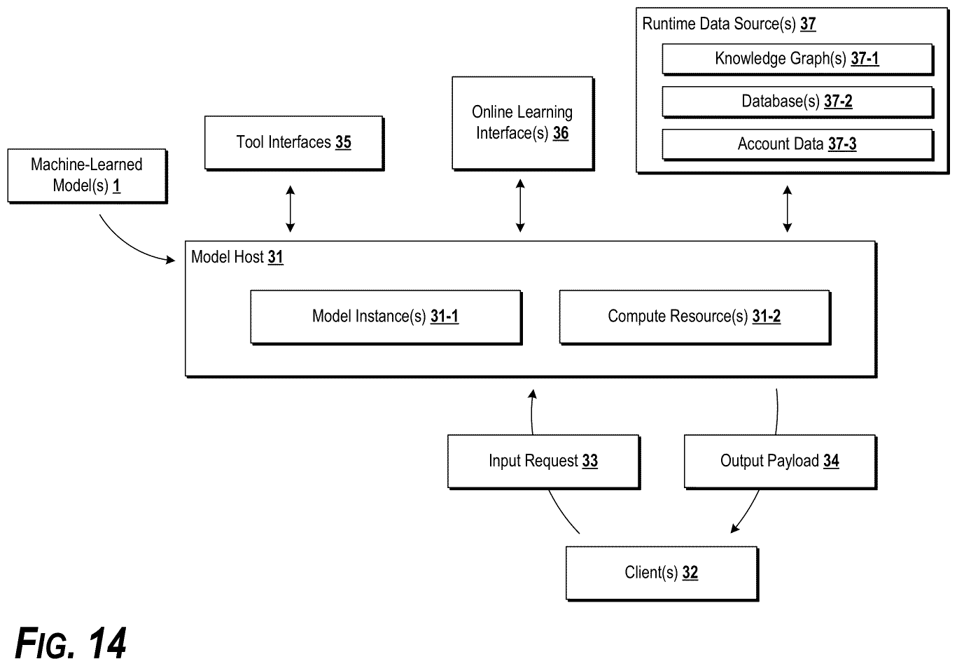

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

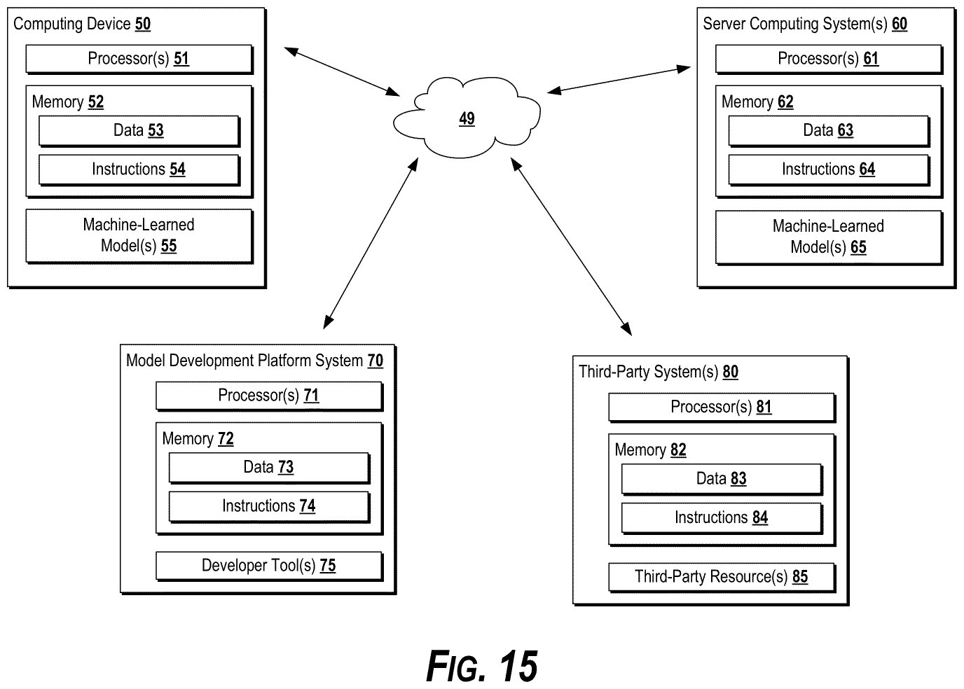

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

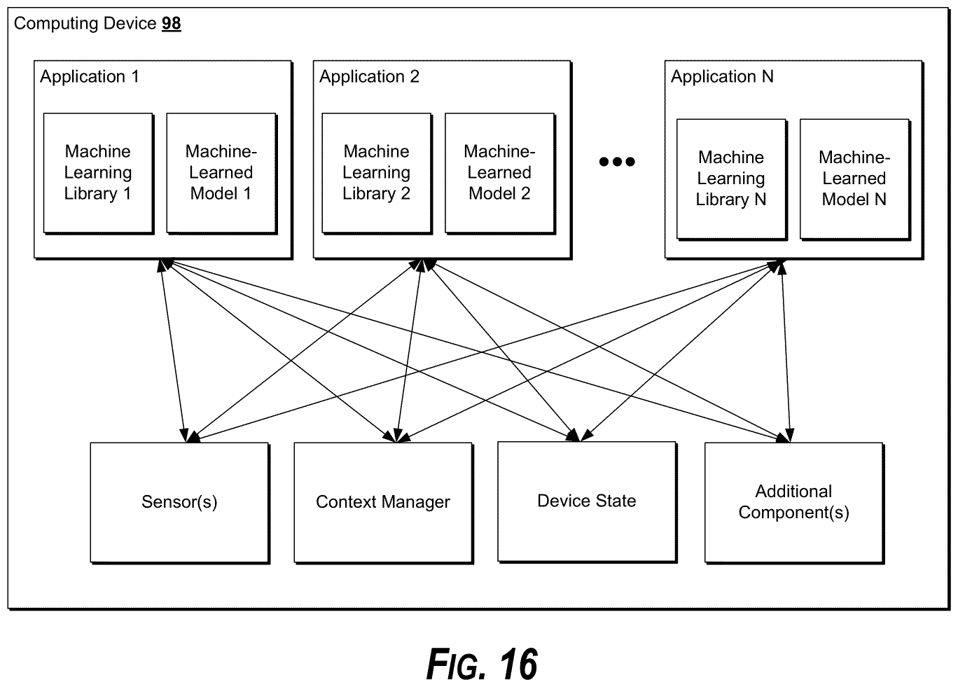

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

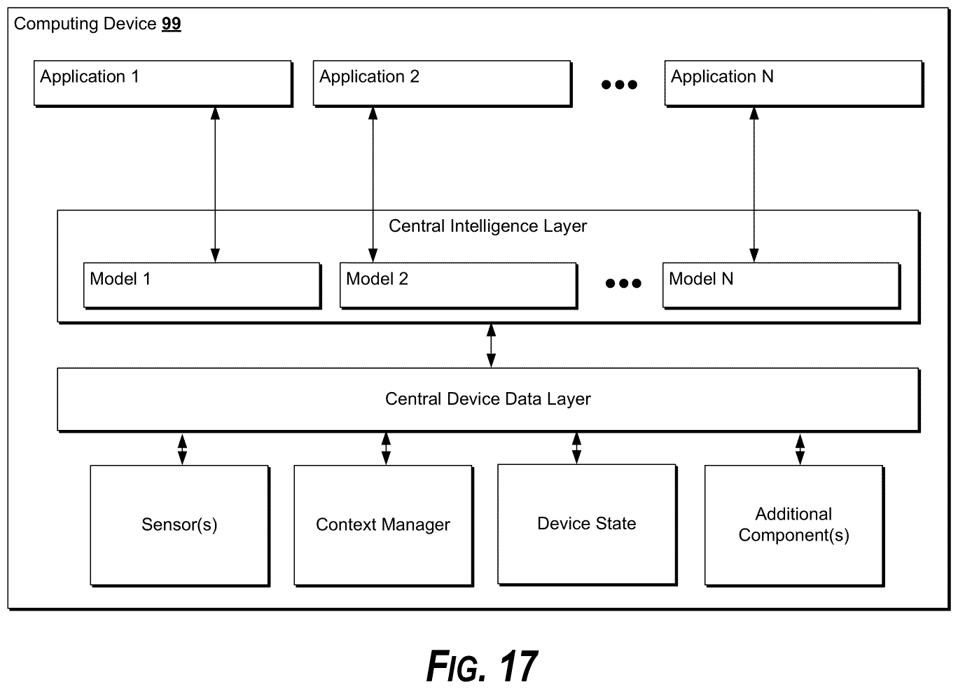

FIG. 17 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for training a machine-learned sequence processing model, the method comprising:
obtaining, by a computing system comprising one or more processors, a plurality of training examples for training the machine-learned sequence processing model, wherein each training example of the plurality of training examples comprises an example query, an example response to the query, and an example trace of intermediate states from the example query to the example response; and
for each respective training example of the plurality of training examples:
obtaining, by the computing system, a respective query associated with the respective training example;
inputting, by the computing system, the respective query to the machine-learned sequence processing model;
obtaining, by the computing system and from the machine-learned sequence processing model:
a response to the respective query; and
a trace of intermediate states from the respective query to the response;
evaluating, by the computing system, the response using a ground truth response associated with the respective training example;
evaluating, by the computing system, the trace using a ground truth trace associated with the respective training example, wherein the ground truth trace was obtained from annotations that were input by a human user after being presented with the query and the ground truth response, wherein the annotations comprise a description of step-by-step reasoning between the respective query and the ground truth response; and
updating, by the computing system, one or more parameters of the machine-learned sequence processing model based on the evaluation of the response and based on the evaluation of the trace.

2. The method of claim 1, wherein the plurality of training examples comprises examples from multiple different task categories.

3. The method of claim 2, wherein the task categories comprise at least one or more of:
question generation;
explanation generation; or
question and answer generation.

4. The method of claim 2, wherein the respective training example is associated with a particular task determined by selecting a dataset;
selecting a task category;
selecting an instruction template associated with the task category, wherein the instruction template is configured to induce the machine-learned sequence processing model to generate traces when generating responses to input queries; and
populating the instruction template using data from the dataset to obtain the respective query of the respective training example.

5. The method of claim 4, wherein the instruction template is selected from a plurality of instruction templates.

6. The method of claim 5, wherein the plurality of instruction templates comprises at least ten instruction templates.

7. The method of claim 4, wherein populating the instruction template comprises:
populating the instruction template with one or more exemplar delimiters selected randomly from a plurality of exemplar delimiters.

8. The method of claim 1, comprising:
training, by the computing system, the machine-learned sequence processing model using other training examples without ground truth traces.

9. The method of claim 8, wherein the plurality of training examples are less than ten percent of a sum of a quantity of the plurality of training examples and a quantity of the other training examples without ground truth traces.

10. The method of claim 1, wherein the respective query comprises an exemplar query, an exemplar trace, and an exemplar response.

11. The method of claim 1, wherein the respective query does not comprise an exemplar trace.

12. The method of claim 1, wherein the response and the trace are generated in a single forward pass of the machine-learned sequence processing model.

13. The method of claim 1, wherein the query comprises an instruction, and wherein the one or more parameters are updated to increase a likelihood that the machine-learned sequence processing model generates an output that follows the instruction.

14. The method of claim 1, wherein the trace comprises a chain of intermediate responses to intermediate queries.

15. A computing system for training a machine-learned sequence processing model, the computing system comprising:
one or more processors; and
one or more non-transitory computer-readable media storing instructions that are executable by the one or more processors to cause the computing system to perform operations, the operations comprising:
obtaining a plurality of training examples for training the machine-learned sequence processing model, wherein each training example of the plurality of training examples comprises an example query, an example response to the query, and an example trace of intermediate states from the example query to the example response; and
for each respective training example of the plurality of training examples:
obtaining a respective query associated with the respective training example;
inputting the respective query to the machine-learned sequence processing model;
obtaining, from the machine-learned sequence processing model:
a response to the respective query; and
a trace of intermediate states from the respective query to the response;
evaluating the response using a ground truth response associated with the respective training example;
evaluating the trace using a ground truth trace associated with the respective training example, wherein the ground truth trace was obtained from annotations that were input by a human user after being presented with the query and the ground truth response, wherein the annotations comprise a description of step-by-step reasoning between the respective query and the ground truth response; and
updating one or more parameters of the machine-learned sequence processing model based on the evaluation of the response and based on the evaluation of the trace.

16. The computing system of claim 15, wherein the plurality of training examples comprises examples from multiple different task categories.

17. The computing system of claim 16, wherein the respective training example is associated with a particular task determined by
selecting a dataset;
selecting a task category;
selecting an instruction template associated with the task category, wherein the instruction template is configured to induce the machine-learned sequence processing model to generate traces when generating responses to input queries; and
populating the instruction template using data from the dataset to obtain the respective query of the respective training example.

18. The method of claim 1, comprising:
training, by the computing system, the machine-learned sequence processing model using other training examples without ground truth traces;
wherein the plurality of training examples are less than ten percent of a sum of a quantity of the plurality of training examples and a quantity of the other training examples without ground truth traces.

19. A computing system, comprising:
one or more processors; and
one or more non-transitory computer-readable media storing:
a machine-learned sequence processing model that was trained by:
obtaining a plurality of training examples for training the machine-learned sequence processing model, wherein each training example of the plurality of training examples comprises an example query, an example response to the query, and an example trace of intermediate states from the example query to the example response; and
for each respective training example of the plurality of training examples:
obtaining a training query associated with the respective training example;
inputting the training query to the machine-learned sequence processing model;
obtaining, from the machine-learned sequence processing model:
a response to the training query; and
a trace of intermediate states from the training query to the response;
evaluating the response using a ground truth response associated with the respective training example;
evaluating the trace using a ground truth trace associated with the respective training example, wherein the ground truth trace was obtained from annotations that were input by a human user after being presented with the query and the ground truth response, wherein the annotations comprise a description of step-by-step reasoning between the respective query and the ground truth response; and
updating one or more parameters of the machine-learned sequence processing model based on the evaluation of the response and based on the evaluation of the trace; and
instructions that are executable by the one or more processors to cause the computing system to perform operations, the operations comprising:
inputting a runtime query to the machine-learned sequence processing model; and
receiving a runtime response from the machine-learned sequence processing model, wherein the runtime response comprises a runtime trace of intermediate states from the runtime query to the runtime response.

20. The computing system of claim 19, wherein:
the plurality of training examples comprises examples from multiple different task categories; and
the respective training example is associated with a particular task determined by
selecting a dataset;
selecting a task category;
selecting an instruction template associated with the task category, wherein the instruction template is configured to induce the machine-learned sequence processing model to generate traces when generating responses to input queries; and
populating the instruction template using data from the dataset to obtain the respective query of the respective training example.
